(19) United States
(12) Patent Application Publication
(10) Pub. No.: US 2025/0148832 A1
(43) Pub. Date: May 8, 2025

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Tatsuya NAKADA, Tokyo (JP)

(73) Assignee: NEC Corporation, Minato-ku, Tokyo (JP)

(21) Appl. No.: 18/836,799

(22) PCT Filed: Feb. 17, 2022
(86) PCT No.: PCT/JP2022/006359

§ 371 Date: Aug. 8, 2024

(51) Int. Cl. G06V 40/50; G06Q 30/0207; G06V 40/16; G06V 40/60

(52) U.S. Cl. CPC G06V 40/50; G06Q 30/0236; G06V 40/172; G06V 40/60

(57) ABSTRACT

Attained is an object of making it possible to specify a contact detail of a service user and deliver information while reducing time and labor of the service user. To attain the object, an information processing system (1) includes: a first obtaining section (11) which obtains first biometric information from a first terminal which is managed by a service provider; a first registering section (12) which generates first registration information in association with the first biometric information; a second obtaining section (13) which obtains second biometric information from a second terminal which is managed by a service user; and a second registering section (14) which generates second registration information in association with the first registration information and contact detail information which is associated with the second terminal, in a case where the first biometric information and the second biometric information successfully match.

### TECHNICAL FIELD

The present invention relates to a technique of obtaining information pertaining to a service user.

### BACKGROUND ART

There is known a technique of obtaining information pertaining to a service user. For example, Patent Literature 1 discloses a system in which face information pertaining to a visitor (service user) and a handling history regarding the visitor are obtained and registered in a database. In the system, in a case where face information which corresponds to the face information obtained when the visitor visits a store is not stored in the database, the face information is registered in the database as a new visitor. In the system, in a case where face information which corresponds to the face information obtained when the visitor visits the store is stored in the database, a handling history regarding the visitor is displayed. In the system, in a case where the visitor further approves registration of personal information, a contact detail such as an address or a phone number is registered in the database.

### CITATION LIST

### Patent Literature

### [Patent Literature 1]

The specification of Japanese Patent No. 6774125

### SUMMARY OF INVENTION

### Technical Problem

In the system disclosed in Patent Literature 1, there is a possibility that the service user does not approve the registration of the personal information because a procedure for registering the personal information requires time and labor of the service user. In this case, a service provider cannot specify the contact detail of the service user unless the service user visits the store again. Thus, there is a problem that the service provider cannot deliver information to the service user.

An aspect of the present invention has been made in view of the above problem, and an example object thereof is to provide a technique of making it possible to specify a contact detail of a service user and deliver information to the service user while reducing time and labor of the service user.

### Solution to Problem

An information processing system in accordance with an example aspect of the present invention includes: a first obtaining means for obtaining first biometric information from a first terminal which is managed by a service provider; a first registering means for generating first registration information in association with the first biometric information; a second obtaining means for obtaining second biometric information from a second terminal which is managed by a service user; and a second registering means for generating second registration information in association with the first registration information and contact detail information which is associated with the second terminal, in a case where the first biometric information and the second biometric information successfully match.

An information processing method in accordance with an example aspect of the present invention includes: (a) obtaining first biometric information from a first terminal which is managed by a service provider; (b) generating first registration information in association with the first biometric information; (c) obtaining second biometric information from a second terminal which is managed by a service user; and (d) generating second registration information in association with the first registration information and contact detail information which is associated with the second terminal, in a case where the first biometric information and the second biometric information successfully match, wherein at least one processor carries out (a) through (d).

A program in accordance with an example aspect of the present invention causes a computer to function as: a first obtaining means for obtaining first biometric information from a first terminal which is managed by a service provider; a first registering means for generating first registration information in association with the first biometric information; a second obtaining means for obtaining second biometric information from a second terminal which is managed by a service user; and a second registering means for generating second registration information association with the first registration information and contact detail information which is associated with the second terminal, in a case where the first biometric information and the second biometric information successfully match.

### Advantageous Effects of Invention

An aspect of the present invention makes it possible to specify a contact detail of a service user and deliver information to the service user while reducing time and labor of the service user.

### BRIEF DESCRIPTION OF DRAWINGS

FIG. 1 is a block diagram illustrating a configuration of an information processing system in accordance with a first example embodiment of the present invention.

FIG. 2 is a flowchart illustrating a flow of an information processing method in accordance with the first example embodiment of the present invention.

FIG. 3 is a block diagram illustrating a configuration of an information processing system in accordance with a second example embodiment of the present invention.

FIG. 4 is a drawing illustrating a detailed example of a member database in the second example embodiment of the present invention.

FIG. 5 is a drawing illustrating a detailed example of a history database in the second example embodiment of the present invention.

FIG. 6 is a flowchart illustrating a flow of an information processing method in accordance with the second example embodiment of the present invention.

FIG. 7 is a flowchart illustrating a detailed flow of a provisional registration process illustrated in FIG. 6.

FIG. 8 is a schematic view illustrating a detailed example of the information processing method illustrated in FIG. 6.

FIG. 9 is a flowchart illustrating a detailed flow of a history recording process illustrated in FIG. 6.

FIG. 10 is a flowchart illustrating a detailed flow of a definitive registration process illustrated in FIG. 6.

FIG. 11 is a flowchart illustrating a detailed flow of an information delivery process illustrated in FIG. 6.

FIG. 12 is a drawing illustrating an example hardware configuration of each apparatus constituting the information processing system in accordance with each example embodiment of the present invention.

### EXAMPLE EMBODIMENTS

### First Example Embodiment

The following description will discuss a first example embodiment of the present invention in detail with reference to the drawings. The present example embodiment is a basic form of an example embodiment described later.

### <Configuration of Information Processing System 1>

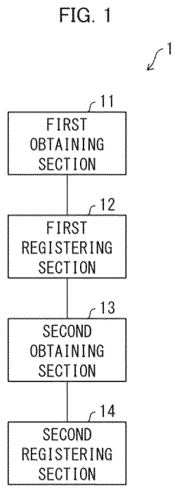

A configuration of an information processing system 1 in accordance with the present example embodiment is described with reference to FIG. 1. FIG. 1 is a block diagram illustrating the configuration of the information processing system 1.

As illustrated in FIG. 1, the information processing system 1 includes a first obtaining section 11, a first registering section 12, a second obtaining section 13, and a second registering section 14. The first obtaining section 11 is an example of a configuration that realizes a first obtaining means recited in the claims. The first registering section 12 is an example of a configuration that realizes a first registering means recited in the claims. The second obtaining section 13 is an example of a configuration that realizes a second obtaining means recited in the claims. The second registering section 14 is an example of a configuration that realizes a second registering means recited in the claims.

The first obtaining section 11 obtains first biometric information from a first terminal which is managed by a service provider. The first registering section 12 generates first registration information in association with the first biometric information. The second obtaining section 13 obtains second biometric information from a second terminal which is managed by a service user. The second registering section 14 generates second registration information in association with the first registration information and contact detail information which is associated with the second terminal, in a case where the first biometric information and the second biometric information successfully match. Details of these sections will be described in “Flow of information processing method S1”, which will be described later.

### <Implementation by Program>

The foregoing functions of the information processing system 1 can also be realized by a program. A program in accordance with the present example embodiment causes a computer to function as: a first obtaining means for obtaining the first biometric information from the first terminal which is managed by the service provider; a first registering means for generating the first registration information in association with the first biometric information; a second obtaining means for obtaining the second biometric information from the second terminal which is managed by the service user; and a second registering means for generating the second registration information in association with the first registration information and the contact detail information which is associated with the second terminal, in a case where the first biometric information and the second biometric information successfully match. For example, at least one processor included in the information processing system 1 executes the program, so that the functions of the foregoing sections included in the information processing system 1 are realized.

### <Flow of Information Processing Method S1>

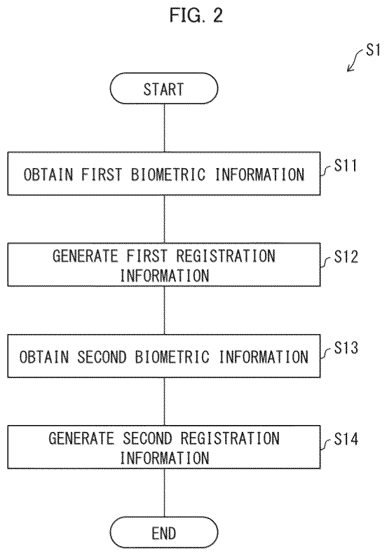

A flow of an information processing method S1 in accordance with the present example embodiment is described with reference to FIG. 2. FIG. 2 is a flowchart illustrating the flow of the information processing method S1. Note that steps included in the information processing method S1 are carried out by the sections included in the information processing system 1. Note, here, that, in a case where the sections are realized by the at least one processor included in the information processing system 1 executing the foregoing program, in other words, the steps included in the information processing method S1 are carried out by the at least one processor. As illustrated in FIG. 2, the information processing method S1 includes steps S11 to S14.

In the step S11, the first obtaining section 11 obtains the first biometric information from the first terminal which is managed by the service provider.

Note, here, that the service provider is a provider of a service. Examples of the service provider include, but are not limited to, business operators which operate stores, commercial facilities, transportations, accommodations, educational facilities, public facilities, and the like.

Examples of the service provided by the service provider include, but are not limited to, services of selling tangible or intangible commodities, services of lending items, places, or the like, services of transporting service users, and services of educating service users. The service provided by the service provider may be a service which requires payment or may be alternatively a service which does not require payment.

The first terminal is disposed, for example, in a place which is managed by the service provider. Examples of the place which is managed by the service provider include, but are not limited to, the foregoing stores, commercial facilities, transportations, accommodations, educational facilities, public facilities, and the like. The first terminal may be disposed stationarily in the place which is managed by the service provider or may be disposed such that the first terminal can be moved. For example, the first terminal may be carried by a worker or the like of the service.

The first biometric information is biometric information detected by the first terminal from a detection target who exists in a range in which the first terminal can detect biometric information.

In the step S12, the first registering section 12 generates the first registration information in association with the first biometric information. For example, the first registration information may include identification information with which the detection target indicated by the first biometric information is identified.

In the step S13, the second obtaining section 13 obtains the second biometric information from the second terminal which is managed by the service user.

Note, here, that the service user is a user of the service which is provided by the service provider. Examples of the second terminal include, but are not limited to, smartphones, tablets, and personal computers of the service user. The second terminal may be disposed in a place which is managed by the service user or may be able to be carried by the service user. The second biometric information is biometric information detected by the second terminal from a detection target who exists in a range in which the second terminal can detect biometric information.

In the step S14, the second registering section 14 generates the second registration information in association with the first registration information and the contact detail information which is associated with the second terminal, in a case where the first biometric information and the second biometric information successfully match. For example, the contact detail information may be information indicating a source of transmission of the second biometric information which source is specified when the second biometric information is obtained by the second obtaining section 13. For example, the second registration information may include identification information with which the service user is identified.

### Effects of the Present Example Embodiment

As has been described, the information processing system 1 and the information processing method S1 in accordance with the present example embodiment each employ a configuration in which the first obtaining section 11 obtains the first biometric information from the first terminal which is managed by the service provider, the first registering section 12 generates the first registration information in association with the first biometric information, the second obtaining section 13 obtains the second biometric information from the second terminal which is managed by the service user, and the second registering section 14 generates the second registration information in association with the first registration information and the contact detail information which is associated with the second terminal, in a case where the first biometric information and the second biometric information successfully match.

According to the above configuration, by providing the first biometric information to the first terminal which is managed by the service provider and providing the second biometric information with use of the second terminal which is managed by the service user, the service user can register the contact detail information associated with the second terminal, and the other procedures are not essential. With this configuration, the present example embodiment makes it possible to easily obtain the contact detail information which is necessary to deliver information to the service user. As a result, the present example embodiment brings about an effect that it is possible to specify a contact detail of the service user and deliver information to the service user, while reducing time and labor of the service user.

### Second Example Embodiment

The following description will discuss a second example embodiment of the present invention in detail with reference to the drawings. In the present example embodiment, an example is described in which a service provider is a sales business operator which sells commodities in a store and a service user is a customer who visits the store. In this case, a service provided by the service provider is a service of selling the commodities. Note that constitutional elements having the same functions as those of the constitutional elements described in the first example embodiment are given the same reference signs, and descriptions thereof will be omitted as appropriate.

<Configuration of information processing system 1A>

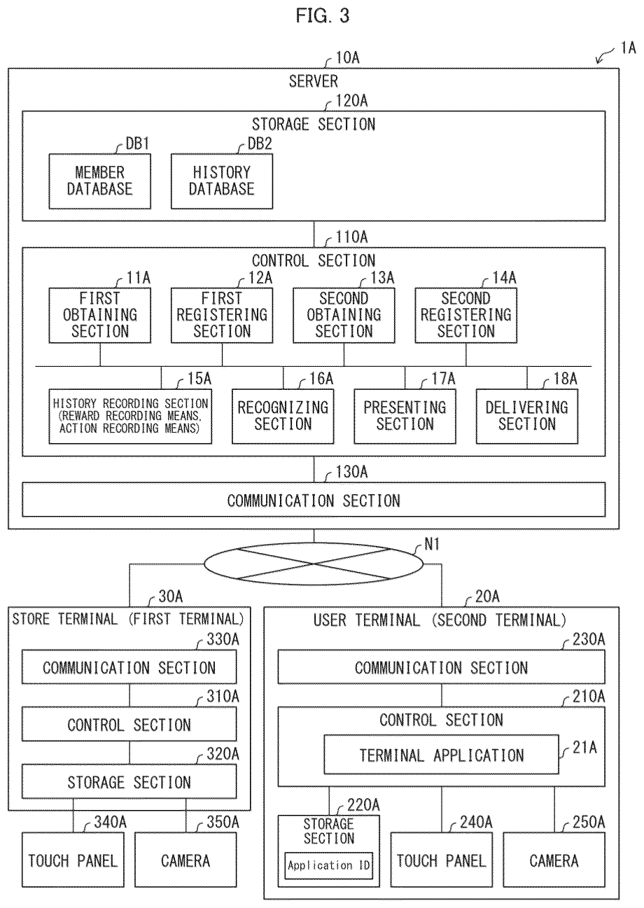

A configuration of an information processing system 1A in accordance with the present example embodiment is described with reference to FIG. 3. FIG. 3 is a block diagram illustrating the configuration of the information processing system 1A.

As illustrated in FIG. 3, the information processing system 1A includes a server 10A, a user terminal 20A, and a store terminal 30A. The server 10A is communicably connected to each of the user terminal 20A and the store terminal 30A via a network N1. The network N1 is constituted by, for example, a wireless local area network (LAN), a wired LAN, a wide area network (WAN), a public network, a mobile data communication network, another network, or a combination of a part or all of these networks. Note that a network via which the server 10A and the user terminal 20A are connected to each other may be different from or identical to a network via which the server 10A and the store terminal 30A are connected to each other.

### (Configuration of Server 10A)

As illustrated in FIG. 3, the server 10A includes a control section 110A, a storage section 120A, and a communication section 130A. The control section 110A collectively controls each section of the server 10A. The storage section 120A stores therein various pieces of data used by the control section 110A. The communication section 130A transmits and receives data to and from another apparatus under control by the control section 110A.

The control section 110A includes a first obtaining section 11A, a first registering section 12A, a second obtaining section 13A, a second registering section 14A, a history recording section 15A, a recognizing section 16A, a presenting section 17A, and a delivering section 18A. The history recording section 15A is an example of a configuration that realizes a reward recording means and an action recording means recited in the claims. The presenting section 17A is an example of a configuration that realizes a presenting means recited in the claims. The delivering section 18A is an example of a configuration that realizes a delivering means recited in the claims. Details of these sections will be described in “Flow of information processing method SIA”, which will be described later. The storage section 120A stores therein a member database DB1 and a history database DB2.

### (Member Database DB1)

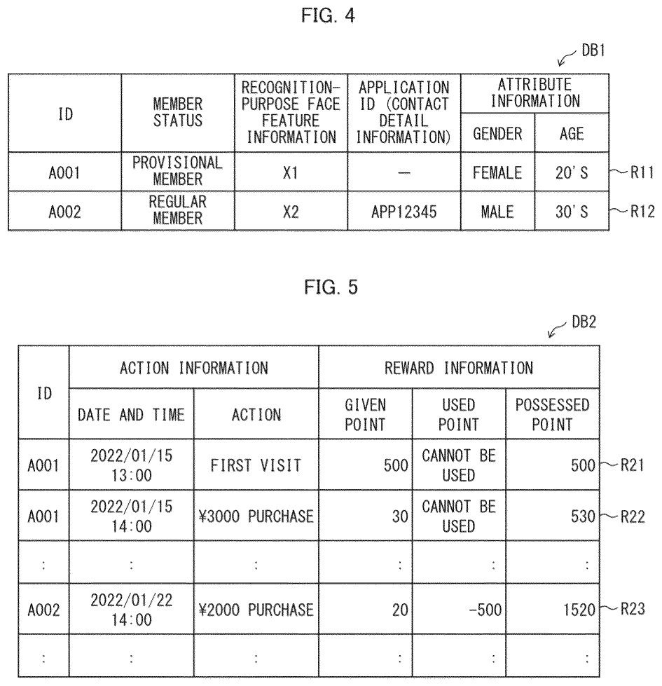

A detailed example of the member database DB is described with reference to FIG. 4. FIG. 4 is a drawing illustrating a detailed example of the member database DB1.

The member database DB1 stores therein member information pertaining to the service user. Each column of the member database DB1 illustrated in FIG. 4 indicates an example of the member information. In this example, the member information includes information indicating an ID, a member status, recognition-purpose face feature information, an application ID, and an age and a gender (attribute information).

The ID is information with which the member information is uniquely identified. The recognition-purpose face feature information is face feature information used to recognize the service user, and is an example of first biometric information recited in the claims. Note that the member information may include information indicating a place where the recognition-purpose face feature information is stored, instead of including the recognition-purpose face feature information itself. In this case, the recognition-purpose face feature information may be stored in the storage section 120A or may be stored in an external apparatus.

The member status is information indicating which one of a provisional member and a regular member the service user is. The application ID is identification information pertaining to a terminal application 21A, which will be described later, and is an example of contact detail information recited in the claims. The gender and the age are examples of the attribute information, which will be described later.

In the example in FIG. 4, the member database DB1 includes member information R11 and member information R12. The member information R11, in which the member status is “provisional member”, does not include the application ID. Hereinafter, such member information is also referred to as “provisional member information”. The provisional member information is an example of first registration information recited in the claims. Hereinafter, newly creating such provisional member information and recording the provisional member information in the member database DB1 is also referred to as “provisional registration”, “provisional registration process”, or the like. The service user who is a detection target indicated by the recognition-purpose face feature information included in the provisional member information is also referred to as, for example, “provisional member” or “provisional member A001” with an ID “A001” or the like annexed.

The member information R12, in which the member status is “regular member”, includes the application ID. Hereinafter, such member information is also referred to as “regular member information”. The regular member information is an example of second registration information recited in the claims. The regular member information is generated by changing the member status in the provisional member information to the regular member and including the application ID. Generating the regular member information by changing the provisional member information in this manner is hereafter also referred to as “definitive registration”, “definitive registration process”, and the like. The service user who is a detection target indicated by the recognition-purpose face feature information included in the regular member information is also referred to as, for example, “regular member” or “regular member A002” with an ID “A002” or the like annexed.

Note, however, that, in a case where it is not particularly necessary to distinguish between the provisional member (or the provisional member information) and the regular member (or the regular member information), each of the provisional member (or the provisional member information) and the regular member (or the regular member information) is simply referred to as “member (member information)”.

Note that a data structure of the member database DB1 is not limited to that illustrated in FIG. 4, and only needs to be a data structure in which it is possible to associate the provisional member information and the recognition-purpose face feature information and possible to associate the provisional member information and the regular member information.

### (History Database DB2)

A detailed example of the history database DB2 is described with reference to FIG. 5. FIG. 5 is a drawing illustrating the detailed example of the history database DB2. The history database DB2 stores therein history information. Each column of the history database DB2 illustrated in FIG. 5 indicates an example of the history information. In this example, the history information includes action information and reward information.

The action information is information pertaining to an action of the provisional member or the regular member (the detection target indicated by the recognition-purpose face feature information). In this detailed example, the action information includes information indicating a date and time and the action, and detailed examples of the action include “first visit”, “re-visit”, and “x-yen purchase”. Note that the detailed examples of the action are not limited to these examples, and may include food tasting (drink tasting, fitting), requesting an estimation, leaving the store, and the like, but are not limited to these examples.

The reward information is information pertaining to a reward given to the provisional member or the regular member (the detection target indicated by the recognition-purpose face feature information). Note, here, that the reward given to the provisional member may be a reward which becomes able to be used after the definitive registration. “Becoming able to be used after the definitive registration” indicates that the reward cannot be used at least before the definitive registration, and the reward may become able to be used immediately after the definitive registration or may become able to be used from a given point in time after the definitive registration. In this detailed example, the reward is a point(s) indicating a value which can be applied to a part or all of a purchase amount. The point(s) cannot be used before the definitive registration, and becomes able to be used after the definitive registration.

The reward information also includes information indicating a given point(s), a used point(s), and a possessed point(s). The given point(s) is/are a point(s) given to the provisional member or the regular member in accordance with the action of the provisional member or the regular member. In this example, 500 points are given as the reward corresponding to the provisional registration (first visit). Further, a point(s) equal to a given proportion of the purchase amount is/are given as the reward corresponding to purchase. The possessed point(s) is/are a point(s) possessed by the provisional member or the regular member. When a point(s) is/are given, the possessed point(s) is/are updated to a value obtained by adding the given point(s). The used point(s) is/are a part or all of the possessed point(s), and is/are a point(s) used to be applied to a part of the purchase amount. When the point(s) is/are used, the possessed point(s) is/are updated to a value obtained by subtracting the used point(s).

In the example in FIG. 5, the history database DB2 includes history information R21, history information R22, and history information R23. Each of the history information R21 and the history information R22 is history information pertaining to the provisional member A001 illustrated in FIG. 4. The history information R23 is history information pertaining to the regular member A002 illustrated in FIG. 4.

Note that a data structure of the history database DB2 is not limited to that illustrated in FIG. 5, and only needs to be a data structure in which it is possible to associate the member information with the history information.

### (Configuration of User Terminal 20A)

A configuration of the user terminal 20A is described with reference to FIG. 3. The user terminal 20A is a terminal which is managed by the service user and is an example of a second terminal recited in the claims. The user terminal 20A may be, for example, a portable type or a stationary type. Note that, although FIG. 3 illustrates a single user terminal 20A, the information processing system 1A may include a plurality of user terminals 20A.

As illustrated in FIG. 3, the user terminal 20A includes a control section 210A, a storage section 220A, a communication section 230A, a touch panel 240A, and a camera 250A. The control section 210A collectively controls each section of the user terminal 20A. The storage section 220A stores therein various pieces of data used by the control section 210A. The communication section 230A transmits and receives data to and from another apparatus under control by the control section 210A. The touch panel 240A accepts an input operation (for example, a touch operation conducted with use of a finger, a pen, or the like). The touch panel 240A displays information under control by the control section 210A. The camera 250A captures an image of a vicinity of the camera 250A, and generates a captured image.

### (Terminal Application 21A)

The control section 210A includes the terminal application 21A. Note, however, that the terminal application 21A only needs to be included in the control section 210A when the definitive registration process, which will be described later, is carried out, and does not need to be included in the control section 210A when the provisional registration process and a history recording process, each of which will be described later, are carried out. The terminal application 21A is a function realized by the control section 210A reading and executing a terminal application program (not illustrated) stored in the storage section 220A. The terminal application 21A is a dedicated application which is provided to the service user by the service provider. The terminal application 21A includes at least (i) a function of capturing a face image of the service user and transmitting a definitive registration request to the server 10A and (ii) a function of displaying information delivered from the server 10A. Details of the terminal application 21A will be described in “Flow of information processing method SIA”, which will be described later.

### (Application ID)

The storage section 220A also stores therein the application ID. The application ID is identification information pertaining to the terminal application 21A, and is a value unique to each user terminal 20A in which the terminal application 21A is installed. The application ID is an example of “identification information pertaining to an application which operates in the second terminal” recited in the claims.

The application ID may be determined, for example, when the terminal application 21A is executed for the first time in the user terminal 20A. The application ID may be determined by the server 10A or may be determined by the terminal application 21A.

When the terminal application 21A communicates with the server 10A, the terminal application 21A uses the application ID as information with which a source of communication is specified. For example, information transmitted from the terminal application 21A to the server 10A includes the application ID as a source of transmission. Information received by the terminal application 21A from the server 10A includes the application ID as a destination. In other words, by designating the application ID as a destination, the server 10A can deliver information to the service user who manages the user terminal 20A in which the terminal application 21A having the application ID is installed.

### (Configuration of Store Terminal 30A)

A configuration of the store terminal 30A is described with reference to FIG. 3. The store terminal 30A is a terminal which is managed by the service provider and is an example of a first terminal recited in the claims. The store terminal 30A is disposed in the store, for example. The store terminal 30A may be, for example, a portable type or a stationary type.

As illustrated in FIG. 3, the store terminal 30A includes a control section 310A, a storage section 320A, and a communication section 330A. The store terminal 30A is connected to a touch panel 340A and a camera 350A. The control section 310A collectively controls each section of the store terminal 30A. The storage section 320A stores therein various pieces of data used by the control section 310A. The communication section 330A transmits and receives data to and from another apparatus under control by the control section 310A. The touch panel 340A accepts an input operation (for example, a touch operation conducted with use of a finger, a pen, or the like). The touch panel 340A also displays information under control by the control section 310A. The camera 350A captures an image of a vicinity of the camera 350A, and generates a captured image.

Note that, although FIG. 3 illustrates a single store terminal 30A, the information processing system 1A may include a plurality of store terminals 30A. For example, a certain store terminal 30A may be disposed at an entrance of the store, and another store terminal 30A may be disposed in an accounting place (register). Note also that, although FIG. 3 illustrates a single set of the touch panel 340A and the camera 350A, the information processing system 1A may include a plurality of touch panels 340A and/or a plurality of cameras 350A. For example, a certain camera 350A may be disposed at the entrance of the store, and another camera 350A may be disposed in the accounting place. Similarly, a certain touch panel 340A may be disposed at the entrance of the store, and another touch panel 340A may be disposed in the accounting place. The number of touch panels 340A or cameras 350A connected to a single store terminal 30A may be one or more.

### <Flow of Information Processing Method S1A>

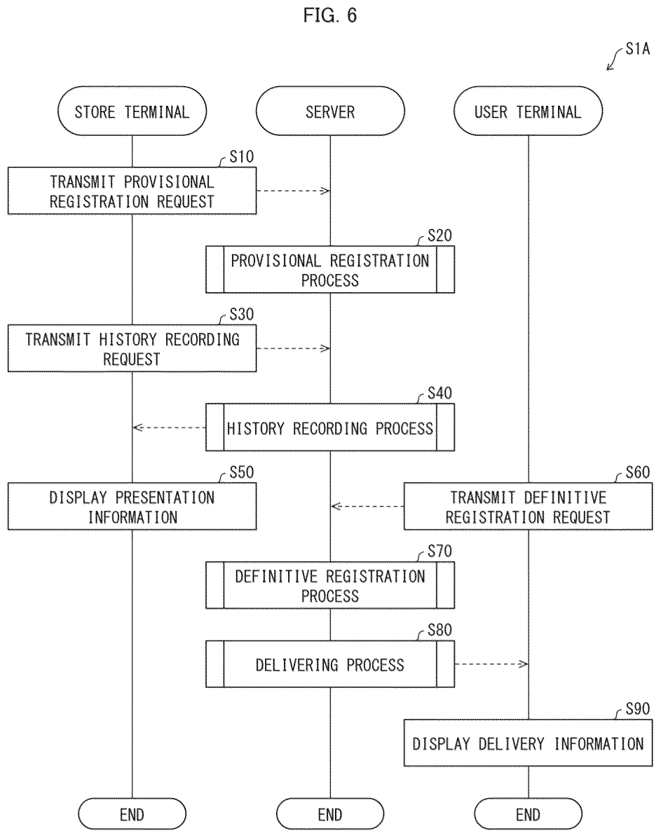

The information processing system 1A configured as described above carries out an information processing method SIA in accordance with the present example embodiment. A flow of the information processing method SIA is described with reference to FIG. 6. FIG. 6 is a flowchart illustrating the flow of the information processing method SIA. As illustrated in FIG. 6, the information processing method SIA includes steps S10 to S90. Note that FIG. 6 does not necessarily indicate that the steps S10 to S90 are carried out in this order. A part or all of the steps may be carried out in different order or in parallel.

### (Step S10)

In the step S10, the control section 310A of the store terminal 30A captures a face image of the service user who has visited the store, and transmits, to the server 10A, a provisional registration request including the face image. Note that capturing the face image of the service user and transmitting the provisional registration request including the face image may be premised on obtaining consent of the service user before carrying out this step. Note, however, that details of this premise and details of a method for obtaining the consent are determined in accordance with a policy of the service provider.

### (Step S20)

In the step S20, the control section 110A of the server 10A carries out the provisional registration process on the basis of the received provisional registration request.

### (Detailed Flow of Step S20)

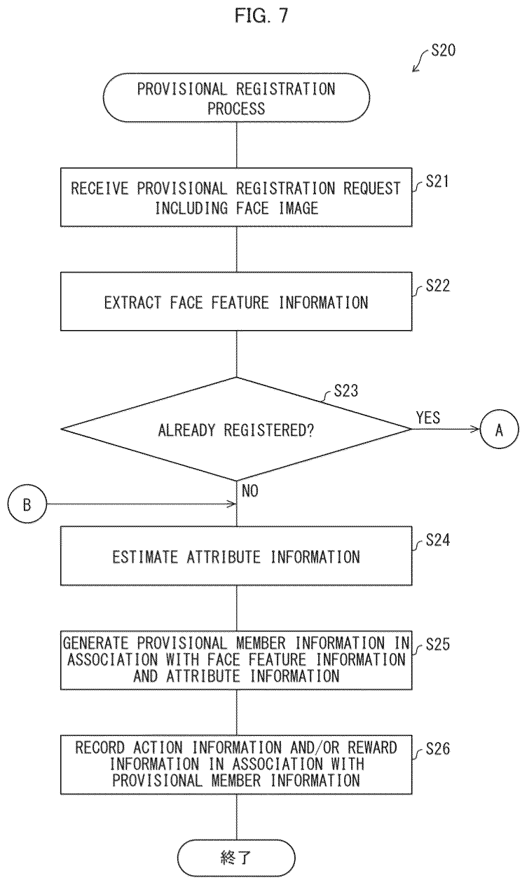

Details of the provisional registration process in the step S20 are described with reference to FIG. 7. FIG. 7 is a flowchart illustrating a detailed flow of the provisional registration process. As illustrated in FIG. 7, the provisional registration process includes steps S21 to S25. Note that FIG. 7 does not necessarily indicate that the steps S21 to S25 are carried out in this order. A part or all of the steps may be carried out in different order or in parallel.

In the step S21, the first obtaining section 11A receives, from the store terminal 30A, the provisional registration request including the face image of the service user.

In the step S22, the first obtaining section 11A extracts face feature information from the received face image. The face feature information is an example of the first biometric information recited in the claims.

In the step S23, the recognizing section 16A determines whether the extracted face feature information has been already registered in the member database DB1. Specifically, the recognizing section 16A determines whether there is recognition-purpose face feature information which has been already registered as member information in the member database DB1 and which successfully match the extracted face feature information.

In a case where a determination of Yes is made in the step S23, the service user, who is a detection target indicated by the extracted face feature information, is already a provisional member or a regular member. Thus, in this case, the server 10A carries out the history recording process, which is described later with reference to another drawing, instead of carrying out the provisional registration process.

In a case where a determination of No is made in the step S23, the step S24 is carried out. Note that processes from the step S24 are carried out also in a case where it is determined, in the history recording process described later, that registration has not been conducted yet. In the step S24, the first registering section 12A estimates attribute information pertaining to the service user, who is a detection target indicated by the received face image, on the basis of the extracted face feature information. The attribute information indicates, for example, a gender, an age, or the like, but is not limited to these examples.

In the step S25, the first registering section 12A generates provisional member information in association with the face feature information and the attribute information. For example, in the example illustrated in FIG. 4, the first registering section 12A issues the ID “A001”. The first registering section 12A also newly generates the member information R11 including the ID “A001” and the member status “provisional member”, and registers the member information R11 in the member database DB1. The first registering section 12A also includes, in the member information R11, the face feature information X1 extracted in the step S22 as recognition-purpose face feature information. The first registering section 12A also includes, in the member information R11, an attribute estimated in the step S24.

In the step S26, the history recording section 15A records one or both of action information and reward information in association with the provisional member information generated in the step S25. For example, in the example illustrated in FIG. 5, the history recording section 15A generates the history information R21 including the ID “A001”, and registers the history information R21 in the history database DB2. The history recording section 15A also includes, in the history information R21, the date and time “2022/01/15 13:00” and the action “first visit”. The date and time may be, for example, a date and time at which the received face image was captured, a date and time at which the provisional registration request was received, a date and time at which this step was carried out, or the like, but are not limited to these examples. The history recording section 15A also includes, in the history information R21, the given points “500”, which correspond to the first visit, and the possessed points “500”. Note that the possessed points “500” indicate a value updated by adding the given points “500” to “0”, which is an initial value of the possessed points.

### (Detailed Examples of Steps S10 and S20)

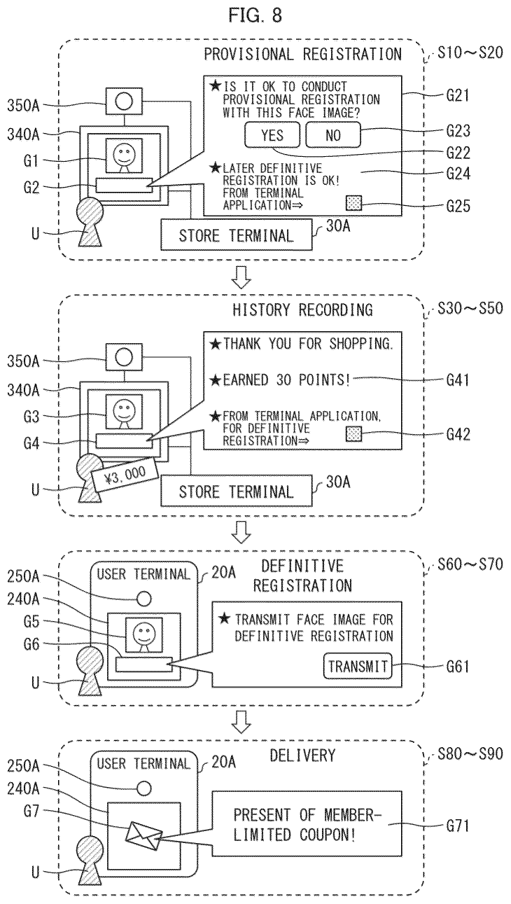

Detailed examples of the steps S10 and S20 are described with reference to FIG. 8. FIG. 8 is a schematic view illustrating a detailed example of the information processing method S1A.

In the example in FIG. 8, processes in the steps S10 and S20 are carried out with respect to a service user U who has visited the store for the first time. The control section 310A of the store terminal 30A controls the camera 350A disposed at the entrance of the store to capture a face image G1 of the service user U, and then causes the touch panel 340A to display the face image G1. The control section 310A also causes the touch panel 340A to display a message G2. The message G2 includes information G21 which asks the service user U whether a provisional registration may be conducted with use of the face image G1. The message G2 also includes buttons G22 and G23 via which an input operation of “Yes” and an input operation of “No” are respectively accepted. The message G2 also includes information G24 which indicates that later definitive registration is OK and download source information G25 which indicates a source of download of the terminal application 21A for conducting the definitive registration. The download source information G25 may be, for example, a character string indicating a uniform resource identifier (URI), a one-dimensional code, a multi-dimensional code, or the like, but is not limited to these examples. In a case where the control section 310A accepts the input operation conducted on the button G22 indicating “Yes”, the control section 310A transmits, to the server 10A, a provisional registration request including the face image G1. The server 10A carries out the provisional registration process with use of the received face image G1. As a result, provisional member information pertaining to the service user U is registered, and the service user U becomes a provisional member.

### (Step S30)

In the step S30 in FIG. 6, in a case where the control section 310A of the store terminal 30A detects an action (visit, purchase, or the like) of the service user, the control section 310A transmits, to the server 10A, a history recording request including a face image of and action information pertaining to the service user.

For example, in a case where the camera 350A disposed at the entrance of the store captures a face image of the service user, the control section 310A detects an action “visit” of the service user. In this case, for example, the control section 310A transmits, to the server 10A, a history recording request including the face image and action information which includes a date and time (for example, a date and time of image capturing) and the action “visit”. For example, in a case where an employee inputs a purchase amount of x yen into the store terminal 30A disposed in the accounting place, the control section 310A detects an action “purchase” of the service user. In this case, for example, the control section 310A transmits, to the server 10A, a history recording request including (i) action information which includes a date and time (for example, a date and time of input of the purchase amount) and the action “x-yen purchase” and (ii) a face image captured by the camera 350A disposed in the accounting place.

### (Step S40)

In the step S40, the control section 110A of the server 10A carries out the history recording process on the basis of the received history recording request.

### (Detailed Flow of Step S40)

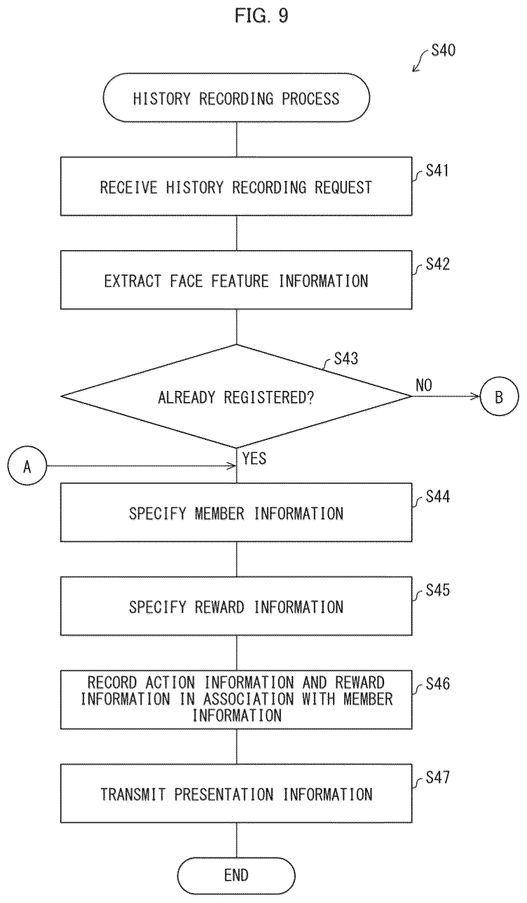

Details of the history recording process in the step S40 are described with reference to FIG. 9. FIG. 9 is a flowchart illustrating a detailed flow of the history recording process. As illustrated in FIG. 9, the history recording process includes steps S41 to S47. Note that FIG. 9 does not necessarily indicate that the steps S41 to S47 are carried out in this order. A part or all of the steps may be carried out in different order or in parallel.

In the step S41, the history recording section 15A of the server 10A receives, from the store terminal 30A, the history recording request including the face image and the action information.

In the step S42, the history recording section 15A extracts face feature information from the received face image.

In the step S43, the recognizing section 16A determines whether the extracted face feature information has been already registered in the member database DB1. Specifically, the recognizing section 16A determines whether there is recognition-purpose face feature information which has been already registered as member information in the member database DB1 and which successfully match the extracted face feature information. In a case where a determination of No is made in this step, the history recording section 15A carries out the processes from the step S24 in the provisional registration process described with reference to FIG. 7.

In a case where a determination of Yes is made in the step S43, the step S44 is carried out. Note that processes from the step S44 are carried out also in a case where it is determined, in the provisional registration process described with reference to FIG. 7, that registration has been already conducted. In the step S44, the recognizing section 16A specifies the member information which has succeeded in matching, with use of a matching result in the step S43.

In the step S45, the history recording section 15A specifies, in accordance with the action information, reward information pertaining to a reward given to the service user corresponding to the member information. Note that the control section 110A of the server 10A may be configured to determine the reward information which corresponds to the action information or may be configured to obtain the reward information which has been determined by another apparatus different from the server 10A.

In the step S46, the history recording section 15A records the received action information and the specified reward information in association with the member information specified in the step S44.

Note, here, that, in a case where the member information specified in the step S44 is provisional member information, the process in the step S46 is carried out during a period from generation of the provisional member information to generation of regular member information. The specified reward information is information pertaining to the reward given to a detection target indicated by the recognition-purpose face feature information included in the provisional member information which has succeeded in matching. Therefore, in this case, in other words, during the period from the generation of the provisional member information (first registration information) to the generation of the regular member information (second registration information), the history recording section 15A records, in association with the provisional member information (first registration information), the reward information pertaining to the reward given to the detection target indicated by the recognition-purpose face feature information (first biometric information).

Furthermore, in a case where the member information specified in the step S44 is provisional member information, the received action information is action information pertaining to the detection target indicated by the recognition-purpose face feature information included in the provisional member information which has succeeded in matching. Therefore, in other words, during the period from the generation of the provisional member information (first registration information) to the generation of the regular member information (second registration information), the history recording section 15A records, in association with the provisional member information (first registration information), the action information pertaining to the action of the detection target indicated by the recognition-purpose face feature information (first biometric information).

In a case where the member information specified in the step S44 is regular member information, the process in the step S46 is carried out after generation of the regular member information. Therefore, in this case, in other words, after the generation of the regular member information (second registration information), the history recording section 15A records the reward information in association with the regular member information (second registration information).

Furthermore, in a case where the member information specified in the step S44 is regular member information, in other words, after the generation of the regular member information (second registration information), the history recording section 15A records the action information in association with the regular member information (second registration information).

For example, it is assumed that the provisional member information R11 illustrated in FIG. 4 is specified on the basis of the face feature information extracted from the received face image. In this case, the history recording section 15A generates the history information R22 including the ID “A001”, and registers the history information R22 in the history database DB2, as illustrated in FIG. 5. It also assumed that the received action information includes the date and time “2022/1/15 14:00” and the action “¥3000 purchase”. In this case, the history recording section 15A records, in the history information R22, the action information, the given points “30”, which corresponds to the action “¥3000 purchase”, and the updated possessed points “530”.

Alternatively, for example, it is assumed that the regular member information R12 illustrated in FIG. 4 is specified on the basis of the face feature information extracted from the received face image. In this case, the history recording section 15A generates the history information R23 including the ID “A002”, and registers the history information R23 in the history database DB2, as illustrated in FIG. 5. It also assumed that the received action information includes the date and time “2022/1/22 14:00” and the actions “¥2000 purchase” and “use of 500 points”. In this case, the history recording section 15A records, in the history information R23, the action information, the given points “20”, which correspond to the action “¥2000 purchase”, the used points “−500”, and the updated possessed points “1520”.

In the step S47, the presenting section 17A transmits, to the store terminal 30A, presentation information to be presented to the provisional member or the regular member. For example, the presentation information may include the reward information pertaining to the given reward.

For example, in a case where the member information specified in the step S44 is provisional member information, the presentation information may include information encouraging definitive registration. In other words, during the period from the generation of the provisional member information (first registration information) to the generation of the regular member information (second registration information), the presenting section 17A presents information encouraging an action for generating the regular member information (second registration information) to the detection target indicated by the recognition-purpose face feature information (first biometric information).

### (Step S50)

In the step S50 in FIG. 6, the control section 310A of the store terminal 30A causes the touch panel 340A to display the received presentation information.

### (Detailed Examples of Steps S30 to S50)

Detailed examples of the steps S30 to S50 are described with reference to the foregoing FIG. 8.

In the example in FIG. 8, processes in S30 to S50 are carried out in response to detection of an action “purchase” of the service user U who is a provisional member. The control section 310A of the store terminal 30A disposed in the accounting place accepts an input of “¥3000 purchase”. The control section 310A controls the camera 350A disposed in the accounting place to capture a face image G3 of the service user U. The control section 310A transmits, to the server 10A, a history recording request including the face image G3, the action “¥3000 purchase”, and a date and time “2022/1/15 14:00”. The history recording section 15A of the server 10A carries out the history recording process, so that, as described above, the provisional member information R11 is specified, and the history information R22 is recorded. The presenting section 17A transmits, to the store terminal 30A, presentation information G4 to be presented to the service user U. The control section 310A of the store terminal 30A causes the touch panel 340A to display the received presentation information G4. The presentation information G4 includes reward information G41 and download source information G42. The reward information G41 includes information indicating “30 points earned”, which have been given in accordance with the action “¥3000 purchase”. The download source information G42 is an example of information encouraging definitive registration, and detailed examples thereof are similar to those of the download source information G25 described above.

For example, the service user U who is a provisional member is expected to install the terminal application 21A in the user terminal 20A which is managed by the service user U, with reference to the download source information G42 displayed on the touch panel 340A in the store. In this case, by the terminal application 21A being activated, an application ID is stored in the storage section 220A. The application ID is as described above.

Note that FIG. 8 illustrates the history recording process which corresponds to the action of the provisional member, as detailed examples of the steps S30 to S50. Note, however, that the history recording process in the steps S30 to S50 is carried out, as described above, not only for the action of the provisional member but also for an action of a regular member. Note also that FIG. 8 illustrates the history recording process which corresponds to the action of purchasing a commodity, as the detailed examples of the steps S30 to S50. Note, however, that the history recording process in the steps S30 to S50 is carried out, as described above, not only for purchase of the commodity but also for another action such as a visit.

### (Step S60)

In the step S60 in FIG. 6, the terminal application 21A of the user terminal 20A captures a face image of the service user who manages the user terminal 20A, and transmits, to the server 10A, a definitive registration request including the face image.

### (Step S70)

In the step S70, the control section 110A of the server 10A carries out the definitive registration process on the basis of the received definitive registration request.

### (Detailed Flow of Step S70)

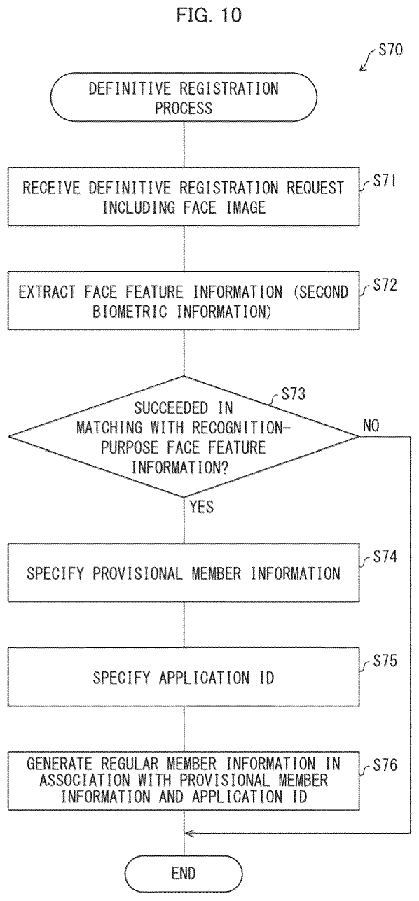

Details of the definitive registration process in the step S70 are described with reference to FIG. 10. FIG. 10 is a flowchart illustrating a detailed flow of the definitive registration process. As illustrated in FIG. 10, the definitive registration process includes steps S71 to S76.

In the step S71, the second obtaining section 13A receives, from the user terminal 20A, the definitive registration request including the face image of the service user.

In the step S72, the second obtaining section 13A extracts face feature information from the received face image. The face feature information is an example of the second biometric information recited in the claims.

In the step S73, the recognizing section 16A determines whether there is recognition-purpose face feature information which has been already registered as provisional member information in the member database DB1 and which successfully match the extracted face feature information. In a case where a determination of No is made in the step S73, the server 10A ends the definitive registration process.

In a case where a determination of Yes is made in the step S73, the step S74 is carried out. In the step S74, the recognizing section 16A specifies the provisional member information which has succeeded in matching, with use of a matching result in the step S73.

In the step S75, the second registering section 14A specifies an application ID. The application ID can be specified with reference to a source of transmission of the definitive registration request received in the step S71, and details of the application ID are as described above.

In the step S76, the second registering section 14A generates regular member information in association with the specified provisional member information and the specified application ID. For example, it is assumed that the provisional member information R11 illustrated in FIG. 4 is specified on the basis of the face feature information extracted from the received face image. In this case, the second registering section 14A changes the member status of the provisional member information R11 from “provisional member” to “regular member”, and records the specified application ID in the provisional member information R11. The regular member information R11 is thus generated.

### (Detailed Examples of Steps S60 and S70)

Detailed examples of the steps S60 and S70 are described with reference to FIG. 8.

In the example in FIG. 8, processes in the steps S60 and S70 are carried out with respect to the service user U who is a provisional member. In the user terminal 20A which is managed by the service user U, the terminal application 21A controls the camera 250A to capture a face image G5 of the service user U, and causes the touch panel 240A to display the face image G5. The terminal application 21A also causes the touch panel 240 to display a message G6. The message G6 includes a button G61 via which an operation of transmitting the face image G5 for definitive registration is accepted. In a case where the terminal application 21A accepts the operation conducted on the button G61, the terminal application 21A transmits, to the server 10A, a definitive registration request including the face image G5. The second registering section 14A of the server 10A carries out the definitive registration process, and updates, for example, the provisional member information R11 described above to the regular member information R11. The regular member information R11 includes an application ID.

### (Step S80)

In the step S80 in FIG. 6, the delivering section 18A of the server 10A carries out a delivering process.

### (Detailed Flow of Step S80)

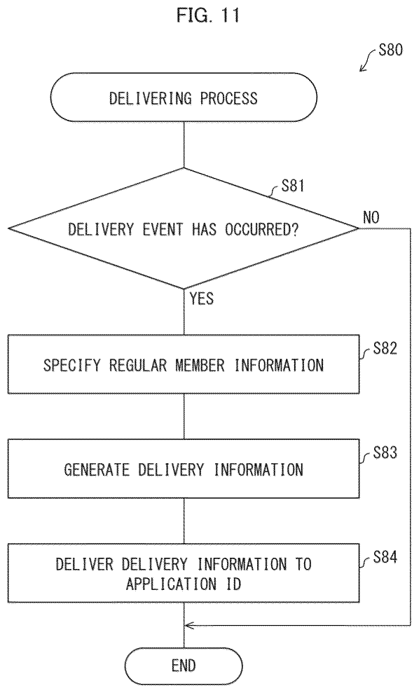

Details of the delivering process in the step S80 are described with reference to FIG. 11. FIG. 11 is a flowchart illustrating a detailed flow of the delivering process. As illustrated in FIG. 11, the delivering process includes steps S81 to S84. Note that FIG. 11 does not necessarily indicate that the steps S81 to S84 are carried out in this order. A part or all of the steps may be carried out in different order or in parallel.

In the step S81, the delivering section 18A determines whether a delivery event has occurred. Note, here, that the delivery event indicates an opportunity of delivering information to a regular member. For example, a timing at which the delivery event occurs may be determined in accordance with one or both of the attribute and an action of the service user. In a case where a determination of No is made in the step S81, the delivering process is ended.

In a case where a determination of Yes is made in the step S81, the step S82 is carried out. In the step S82, the delivering section 18A specifies regular member information at which the delivery event that has occurred is targeted. For example, in a case where, in the step S81, the delivery event targeted at the service user whose attribute and action satisfy given conditions has occurred, the delivering section 18A specifies regular member information which satisfies the given conditions, with reference to the member database DB1 and the history database DB2.

In the step S83, the delivering section 18A generates delivery information. For example, in a case where, in the step S81, the delivery event targeted at the service user whose attribute and action satisfy the given conditions has occurred, the delivering section 18A generates delivery information corresponding to the attribute and the action.

In the step S84, the delivering section 18A delivers the information to a contact detail indicated by an application ID (contact detail information). The application ID is included in the regular member information specified in the step S82. The delivered information is the information generated in the step S83.

Note that the delivering section 18A may determine whether the delivery event has occurred, with use of an estimation model. Note also that the delivering section 18A may generate the delivery information with use of a generation model. Each of such an estimation model and a generation model may be a rule-based model, a machine learning model, or a model which is based on another algorithm. Further, such an estimation model may receive an input including one or both of attribute information and action information, and output information indicating whether the delivery event has occurred. Further, such a generation model may receive an input including one or both of the attribute information and the action information, and output the delivery information.

### (Step S90)

In the step S90, the terminal application 21A of the user terminal 20A causes the touch panel 240A to display the received delivery information. The delivery information includes, as a destination, the application ID stored in the storage section 220A. Note that the terminal application 21A may carry out a so-called push notification, i.e., causes the delivery information to be displayed in response to reception of the delivery information. Note also that the terminal application 21A is not limited to the push notification, and may cause the delivery information to be displayed in response to an activation of the terminal application 21A.

### (Specific Examples of Steps S80 and S90)

Detailed examples of the steps S80 and S90 are described with reference to the foregoing FIG. 8. In the example in FIG. 8, processes in the steps S80 and S90 are carried out with respect to the service user U who is a regular member.

For example, it is assumed that a delivery event targeted at the service user U who has not visited the store for six months has occurred. Such a delivery event occurs, for example, at a timing at which six months have elapsed since a date and time of the last visit, on the basis of history information associated with regular member information, with reference to the member database DB1 and the history database DB2. In this case, the delivering section 18A transmits delivery information G7 corresponding to an action of “having not visited the store for 6 months”, with use of an application ID of the regular member as a destination. The delivery information G7 includes information G71 which indicates “Present of a member-limited coupon” and which encourages a re-visit.

For example, it is assumed that the delivery event targeted at the service user who is in his/her 20s has occurred. Such a delivery event occurs, for example, at a given timing on the basis of attribute information included in the regular member information with reference to the member database DB1. In this case, the delivering section 18A transmits the delivery information G7 corresponding to an attribute “in his/her 20s”, with use of the application ID of the regular member as a destination. In this case, the delivery information G7 includes information (not illustrated) which indicates “Present of a member-limited coupon” and which pertains to a commodity for people in their 20s.

The terminal application 21A of the user terminal 20A causes the touch panel 240A to display the received delivery information G7.

Note that the above-described steps S30 and S40 are carried out in a case where the service user who is a regular member conducts an action such as a visit or purchase. This makes it possible for the service user who is a regular member to take over the reward information pertaining to the reward given during a provisional member and continuously earn or use the reward.

### Effects of the Present Example Embodiment

As has been described, the present example embodiment employs a configuration in which a face image is obtained from the store terminal 30A, provisional member information is generated in association with recognition-purpose face feature information extracted from the face image, a face image is obtained from the user terminal 20A, and, in a case where face feature information extracted from the face image successfully matches the recognition-purpose face feature information, regular member information is generated in association with the provisional member information and an application ID which is associated with the user terminal 20A.

Therefore, in the present example embodiment, it is possible for a service user to conduct provisional registration and definitive registration only by registering a face image. As a result, it is possible to easily obtain an application ID. This brings about an effect that it is possible to easily obtain a contact detail of the service user for delivering information, while reducing time and labor of the service user.

Moreover, the present example embodiment employs a configuration in which information is delivered to a contact detail indicated by the application ID included in the regular member information.

Therefore, the present example embodiment brings about an effect that it is possible for a service provider to deliver, to the service user, information for promoting use of a service.

Furthermore, in the present example embodiment, at a timing at which a delivery event based on attribute information or action information associated with the regular member information has occurred, the delivering section 18A delivers delivery information generated on the basis of the attribute information or the action information.

Therefore, it is possible for the service user to receive personalized information via the terminal application 21A, so that the degree of satisfaction is improved. As a result, it is possible for the service provider to more effectively promote the use of the service by the service user through delivery of the information.

Furthermore, the present example embodiment employs a configuration in which, during a period from generation of the provisional member information to generation of the regular member information, reward information pertaining to a reward given to a provisional member is associated with the provisional member information. Furthermore, the present example embodiment employs a configuration in which, during the period from the generation of the provisional member information to the generation of the regular member information, the action information pertaining to an action of the provisional member is associated with the provisional member information. Furthermore, the present example embodiment employs a configuration in which, after the generation of the regular member information, the reward information and the action information are associated with the regular member information.

Therefore, it is possible for the service provider to obtain an analysis result for providing the service, on the basis of the action information and the reward information each of which is associated with the provisional member information or the regular member information. Such an analysis result can be obtained also from the provisional member information. Therefore, even in a case where the service user remains a provisional member and does not reach definitive registration, an analysis result useful for the service provider is obtained. Furthermore, for example, in a case where a configuration in which the reward information becomes able to be used after the definitive registration is employed, it is possible to increase a motivation of a provisional member to conduct definitive registration.

Further, the present example embodiment employs a configuration in which, during the period from the generation of the provisional member information to the generation of the regular member information, information encouraging an action for generating the regular member information is presented to the provisional member. This makes it possible to increase a motivation of the provisional member to conduct the definitive registration.

### First Modification

In the second example embodiment, an example has been described in which the terminal application 21A is a dedicated application provided by the service provider to the service user. The terminal application 21A is not limited to this example, and may be a general-purpose application. Detailed examples of the general-purpose application include mail applications, social networkin service (SNS) applications, short message service (SMS) applications, and browsers.

### Second Modification

In the second example embodiment, an example has been described in which the contact detail information pertaining to the service user is the application ID (identification information pertaining to the terminal application 21A). The contact detail information pertaining to the service user is not limited to this example, and may be identification information pertaining to the user terminal 20A (second terminal) or may be alternatively an address of the service user which address is registered in the user terminal 20A (second terminal) or the terminal application 21A (application which operates on the second terminal).

The identification information pertaining to the user terminal 20A is, for example, identification information pertaining to a subscriber identity module (SIM) included in the user terminal 20A, a telephone number which is associated with the identification information, or the like. The address of the service user is, for example, a mail address, an SNS account, a telephone number, an address, or the like. Note that “registered in the user terminal 20A” may be being stored in a memory of the user terminal 20A as information which is managed by an operating system of the user terminal 20A. Note also that “registered in the terminal application 21A” may be being stored in the memory of the user terminal 20A or a memory of an external apparatus as information which is managed by the terminal application 21A. Note, however, that the contact detail information pertaining to the service user is not limited to the above-described examples.

### Third Modification

In the second example embodiment, the definitive registration request obtained by the second obtaining section 13A of the server 10A may include, in addition to the face image, user information pertaining to the service user. The user information may include one or both of attribute information and payment information. Such user information may be information inputted by the service user or information detected by the terminal application 21A with use of a sensor (not illustrated). In this case, the second registering section 14A generates the regular member information in association with the provisional member information which has been specified from the face image included in the definitive registration request, the application ID, and the user information which is included in the definitive registration request. For example, in a case where the second registering section 14A specifies the provisional member information R11 in FIG. 4, the second registering section 14A changes the member status of the provisional member information R11 to the regular member, and records the application ID, the estimated attribute information, and the user information which is included in the definitive registration request. The provisional member information R11 is thus updated to the regular member information R11. Note that it is desirable that including the user information in the definitive registration request is not essential.

The terminal application 21A may have a function of additionally registering the user information at a timing different from the definitive registration request. In this case, in a case where an additional registration request including the face image and the user information is received from the user terminal 20A, the second registering section 14A records the user information which is included in the additional registration request, in association with the regular member information which has been specified from a face image included in the additional registration request. For example, in a case where the second registering section 14A specifies the regular member information R12 in FIG. 4, the second registering section 14A updates the regular member information R12 by including, in the regular member information R12, the user information and the like included in the additional registration request.

In the third modification, the history recording section 15A may record, in association with the regular member information, the reward information pertaining to a reward given in accordance with an action “attribute information has been registered”.

Note that, in a case where the registered user information includes the payment information, the control section 310A of the store terminal 30A may conduct payment with use of the payment information included in the regular member information which has been specified from the face image, when the regular member purchases a commodity. This makes it possible for the regular member to make payment only by face recognition in the store.

### Fourth Modification

In the second example embodiment, an example has been described in which the face feature information is used as the first biometric information and the second biometric information. Note, however, that the first biometric information and the second biometric information may be a voice, a voice print extracted from the voice, a fingertip image, a fingerprint extracted from the fingertip image, or another biometric information.

### Fifth Modification

In the second example embodiment, an example has been described in which the face feature information (first biometric information) extracted from the face image included in the provisional registration request is used as the recognition-purpose face feature information. This may be modified such that the recognition-purpose face feature information is updated on the basis of a newly obtained face image. In this case, in a case where the control section 110A of the server 10A specifies the member information on the basis of the history recording request or the definitive registration request, the control section 110A updates the recognition-purpose face feature information which is included in the member information to the face feature information which has been extracted from the face image included in the history recording request or the definitive registration request. This makes it possible to, in the history recording process or the definitive registration process, carry out recognition on the basis of the latest face image of the service user.

### Sixth Modification

In the second example embodiment, the provisional member information pertaining to the service user who has not visited the store for a given period since the provisional registration may be deleted. In this case, the control section 110A of the server 10A extracts, among pieces of provisional member information stored in the member database DB1, the provisional member information which has not been specified for the given period as a target of the history recording request, and deletes the extracted provisional member information. In a case where the provisional member information includes a place where the recognition-purpose face feature information is stored, the control section 110A similarly deletes the recognition-purpose face feature information indicated by this storage place. This makes it possible to effectively use the capacity of the storage section 120A.

### Seventh Modification

In the second example embodiment, an example has been described in which the service provider is a business operator which operates a store. Note, however, that the second example embodiment is also applicable to other types of service providers. Examples of the other types of service providers include business operators which operate stores, commercial facilities, transportations, accommodations, educational facilities, public facilities, and the like, as described in the first example embodiment. As a detailed example, the service user may be a taxi company. In this case, the store terminal 30A is disposed in a taxi. In this case, a customer (service user) who uses the taxi becomes a provisional member when using the taxi company for the first time. After that, each time the customer uses the taxi company before becoming a regular member, a point(s) is/are given. By conducting definitive registration from the user terminal 20A of the customer, the customer can take over the point(s) given while being the provisional member, and can use the point(s) thereafter.

### Eighth Modification

In the second example embodiment, it has been described that the first registering section 12A carries out the provisional registration process and the second registering section 14A carries out the definitive registration process. Moreover, an example has been described in which the first registration information is referred to as provisional member information and the second registration information is referred to as regular member information. Note, however, that the present example embodiment is not limited to embodiments in which the terms “provisional registration”, “definitive registration”, “provisional member”, “regular member”, and the like are used. The present example embodiment is also applicable to a case where the above terms are not used, provided that the first registration information is generated by a first registration process and the service user is brought into a first registration status, and the second registration information is generated by a second registration process and the service user is brought into a second registration status.

### [Software Implementation Example]

A part or all of the functions of each apparatus constituting the information processing system 1, 1A may be implemented by hardware such as an integrated circuit (IC chip), or may be implemented by software.

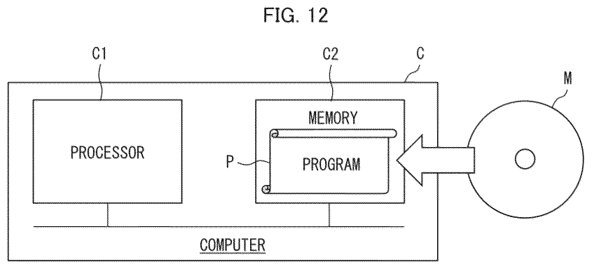

In the latter case, each apparatus constituting the information processing system 1, 1A is realized by, for example, a computer that executes instructions of a program that is software realizing the foregoing functions. FIG. 12 illustrates an example of such a computer (hereinafter, referred to as “computer C”). The computer C includes at least one processor C1 and at least one memory C2. The memory C2 stores therein a program P for causing the computer C to operate as each apparatus constituting the information processing system 1, 1A. In the computer C, the processor C1 reads the program P from the memory C2 and executes the program P, so that the functions of each apparatus constituting the information processing system 1, 1A are realized.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when the program P is executed and in which various kinds of data are temporarily stored. The computer C may further include a communication interface for carrying out transmission and reception of data with another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can obtain the program P via such a recording medium M. The program P can also be transmitted via a transmission medium. Such a transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes. Note, however, that the present invention is not limited to the following example aspects.

### Supplementary Note 1

An information processing system including:
a first obtaining means for obtaining first biometric information from a first terminal which is managed by a service provider;
a first registering means for generating first registration information in association with the first biometric information;
a second obtaining means for obtaining second biometric information from a second terminal which is managed by a service user; and
a second registering means for generating second registration information in association with the first registration information and contact detail information which is associated with the second terminal, in a case where the first biometric information and the second biometric information successfully match.

### Supplementary Note 2

The information processing system as described in Supplementary note 1, further including
a delivering means for delivering information to a contact detail indicated by the contact detail information.

### Supplementary Note 3

The information processing system as described in Supplementary note 1 or 2, wherein the contact detail information is identification information pertaining to the second terminal, identification information pertaining to an application which operates in the second terminal, or an address of the service user which address is registered in the second terminal or the application.

### Supplementary Note 4

The information processing system as described in any one of Supplementary notes 1 through 3, further including
a reward recording means for, during a period from generation of the first registration information to generation of the second registration information, recording, in association with the first registration information, reward information pertaining to a reward given to a detection target indicated by the first biometric information, wherein
after the generation of the second registration information, the reward recording means records the reward information in association with the second registration information.

### Supplementary Note 5

The information processing system as described in any one of Supplementary notes 1 through 4, further including
an action recording means for, during a period from generation of the first registration information to generation of the second registration information, recording, in association with the first registration information, action information pertaining to an action of a detection target indicated by the first biometric information, wherein
after the generation of the second registration information, the action recording means records the action information in association with the second registration information.

### Supplementary Note 6

The information processing system as described in any one of Supplementary notes 1 through 5, further including
a presenting means for, during a period from generation of the first registration information to generation of the second registration information, presenting, to a detection target indicated by the first biometric information, information encouraging an action for generating the second registration information.

### Supplementary Note 7

An information processing method including:
(a) obtaining first biometric information from a first terminal which is managed by a service provider;
(b) generating first registration information in association with the first biometric information;
(c) obtaining second biometric information from a second terminal which is managed by a service user; and
(d) generating second registration information in association with the first registration information and contact detail information which is associated with the second terminal, in a case where the first biometric information and the second biometric information successfully match, wherein at least one processor carries out (a) through (d).

### Supplementary Note 8

A program which causes a computer to function as:
a first obtaining means for obtaining first biometric information from a first terminal which is managed by a service provider;
a first registering means for generating first registration information in association with the first biometric information;
a second obtaining means for obtaining second biometric information from a second terminal which is managed by a service user; and
a second registering means for generating second registration information in association with the first registration information and contact detail information which is associated with the second terminal, in a case where the first biometric information and the second biometric information successfully match.

### Additional Remark 3

The whole or part of the example embodiments disclosed above can also be expressed as follows.

An information processing system including at least one processor, the at least one processor carrying out: a first obtaining process of obtaining first biometric information from a first terminal which is managed by a service provider; a first registering process of generating first registration information in association with the first biometric information; a second obtaining process of obtaining second biometric information from a second terminal which is managed by a service user; and a second registering process of generating second registration information in association with the first registration information and contact detail information which is associated with the second terminal, in a case where the first biometric information and the second biometric information successfully match.

Note that this information processing system may further include a memory. The memory may store therein a program for causing the at least one processor to carry out the first obtaining process, the first registering process, the second obtaining process, and the second registering process. The program may be recorded in a computer-readable non-transitory tangible recording medium.

### REFERENCE SIGNS LIST

1, 1A Information processing system
10A Server
20A User terminal
30A Store terminal
11, 11A First obtaining section
12, 12A First registering section
13, 13A Second obtaining section
14, 14A Second registering section
15A History recording section
16A Recognizing section
17A Presenting section
18A Delivering section
21A Terminal application
110A, 210A, 310A Control section
120A, 220A, 320A Storage section
130A, 230A, 330A Communication section
240A, 340A Touch panel
250A, 350A Camera
C1 Processor
C2 Memory

What is claimed is:

1. An information processing system comprising:
at least one processor,
the at least one processor carrying out:
a first obtaining process of obtaining first biometric information from a first terminal which is managed by a service provider;
a first registering process of generating first registration information in association with the first biometric information;
a second obtaining process of obtaining second biometric information from a second terminal which is managed by a service user; and
a second registering process of generating second registration information in association with the first registration information and contact detail information which is associated with the second terminal, in a case where the first biometric information and the second biometric information successfully match.

2. The information processing system as set forth in claim 1, wherein
the at least one processor further carries out a delivering process of delivering information to a contact detail indicated by the contact detail information.

3. The information processing system as set forth in claim 1, wherein the contact detail information is identification information pertaining to the second terminal, identification information pertaining to an application which operates in the second terminal, or an address of the service user which address is registered in the second terminal or the application.

4. The information processing system as set forth in claim 1, wherein
the at least one processor further carries out a reward recording process of, during a period from generation of the first registration information to generation of the second registration information, recording, in association with the first registration information, reward information pertaining to a reward given to a detection target indicated by the first biometric information, and
after the generation of the second registration information, the at least one processor records the reward information in association with the second registration information in the reward recording process.

5. The information processing system as set forth in claim 1, wherein
the at least one processor further carries out an action recording process of, during a period from generation of the first registration information to generation of the second registration information, recording, in association with the first registration information, action information pertaining to an action of a detection target indicated by the first biometric information, and
after the generation of the second registration information, the at least one processor records the action information in association with the second registration information in the action recording process.

6. The information processing system as set forth in claim 1, wherein
the at least one processor further carries out a presenting process of, during a period from generation of the first registration information to generation of the second registration information, presenting, to a detection target indicated by the first biometric information, information encouraging an action for generating the second registration information.

7. An information processing method comprising:
(a) obtaining first biometric information from a first terminal which is managed by a service provider;
(b) generating first registration information in association with the first biometric information;
(c) obtaining second biometric information from a second terminal which is managed by a service user; and
(d) generating second registration information in association with the first registration information and contact detail information which is associated with the second terminal, in a case where the first biometric information and the second biometric information successfully match, wherein
at least one processor carries out (a) through (d).

8. A non-transitory recording medium in which a program is recorded, the program causing a computer to carry out:
a first obtaining process of obtaining first biometric information from a first terminal which is managed by a service provider;
a first registering process of generating first registration information in association with the first biometric information;
a second obtaining process of obtaining second biometric information from a second terminal which is managed by a service user; and
a second registering process of generating second registration information in association with the first registration information and contact detail information which is associated with the second terminal, in a case where the first biometric information and the second biometric information successfully match.
